(19) United States
(12) Patent Application Publication
(10) Pub. No.: US 2007/0178404 A1
(43) Pub. Date: Aug. 2, 2007

(54) METHODS OF PREVENTING DEFECTS IN ANTIREFLECTIVE COATINGS

(75) Inventors: Colin J. Brodsky, Salt Point, NY (US); Mary Jane Brodsky, Salt Point, NY (US); Wai-Kin Li, Beacon, NY (US); Steven A. Scheer, Austin, TX (US)

Correspondence Address: SCULLY SCOTT MURPHY & PRESSER, PC, 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 11/307,268

(22) Filed: Jan. 30, 2006

(51) Int. Cl. G03C 1/00

(52) U.S. Cl. 430/270.1

(57) ABSTRACT

A method of forming a relief image on a substrate including: applying over a substrate a layer of an antireflective coating; and vacuum processing the antireflective coating. This method reduces the number of pinhole defects present in the antireflective coating.

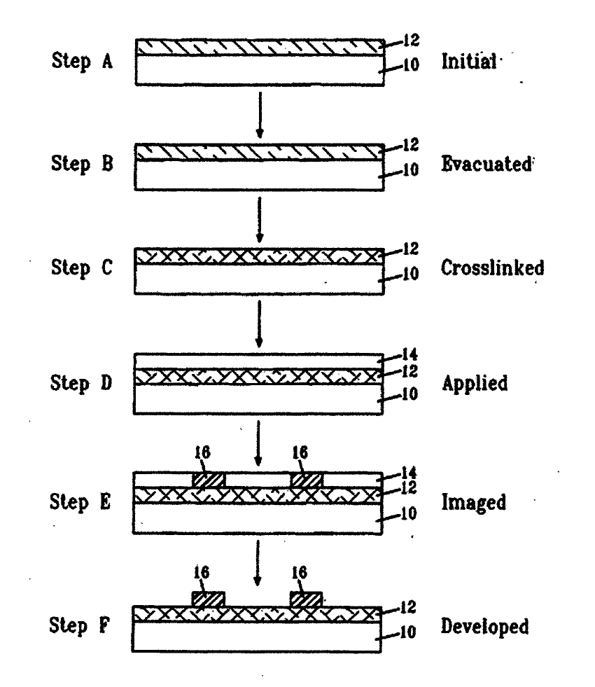

### BACKGROUND OF THE INVENTION

1. Field of the Invention

The present invention relates to new methods of making antireflective coatings. More particularly, the present invention relates to new methods of reducing defects in antireflective coatings.

2. Background Art

Photoresists are used for transfer of an image to a substrate. A coating layer of a photoresist is formed on a substrate, and the resist layer is then selectively exposed through a photomask to a source of activating radiation. The photomask has areas that are opaque to activating radiation and other areas that are transparent to activating radiation. Exposure to activating radiation provides a photoinduced chemical transformation of the photoresist coating to thereby transfer the pattern of the photomask to the resist coated substrate. Following exposure, the photoresist is developed to provide a relief image that permits selective patterning of the substrate.

A photoresist can be either positive-acting or negative-acting. For most negative photoresists, the coating layer portions that are exposed to activating radiation polymerize or crosslink in a reaction between a photoactive compound and polymerizable reagents of the resist composition. Consequently, the exposed coating portions are rendered less soluble in a developer solution than unexposed portions. For a positive-acting photoresist, exposed portions are rendered more soluble in a developer solution, while areas not exposed remain comparatively less developer soluble. The background of photoresists are described by Deforest, Photoresist Materials and Methodes, McGraw Hill Book Company, New York, ch. 2, 1975, and by Moreay, Semiconductor Lithography, Principles, Practices and Materials, Plenum Press, New York, ch. 2 and 4, both incorporated herein by reference for their teaching of photoresists and methods of making and using same.

A major use of photoresists is in semiconductor manufacture where an object is to convert a semiconductor slice, such as silicon or gallium arsenide, into a complex matrix of electron conducting paths, preferably of micron or submicron geometry, that perform circuit functions. More recently, resists have been applied over complex topographical features. Proper photoresist methoding is a key to attaining this object. While there is a strong interdependency among the various photoresist methoding steps, exposure is believed to be one of the most important steps in attaining high resolution photoresist images.

In certain methods of making semiconductor devices, a via or hole is etched through an insulating dielectric layer to expose an underlying layer, and the insulating dielectric layer is then etched again to form a wider trench above the via or contact hole. For example, in a via first dual inlaid dual damascene method, via holes are first etched, and then overlying trenches connecting respective via holes are formed in an inter-level dielectric (ILD). The trenches and vias are filled with a conductive material that connects to an underlying conducting material on the device through the via holes. In this method, a via hole is first etched in a hole formation etch, and then exposed to a second etch in the trench formation etch.

Reflection of the activating radiation used to expose a photoresist often poses notable limits on resolution of the image patterned in the resist layer. Reflection of radiation from the substrate/resist interface can produce variations in the radiation intensity in the resist during exposure, resulting in non-uniform photoresist linewidth upon development. Radiation also can scatter from the substrate/resist interface into regions of the resist where exposure is not intended, again resulting in linewidth variations. The amount of scattering and reflection will typically vary from region to region, resulting in further linewidth non-uniformity.

Reflection of activating radiation also contributes to what is known in the art as the “standing wave effect”. To eliminate the effects of chromatic aberration in exposure equipment lenses, monochromatic or quasimonochromatic radiation is commonly used in resist projection techniques. Due to radiation reflection at the resist/substrate interface, however, constructive and destructive interference is particularly significant when monochromatic or quasi-monochromatic radiation is used for photoresist exposure. In such cases, the reflected light interferes with the incident light to form standing waves within the resist. In the case of highly reflective substrate regions, the problem is exacerbated since large amplitude standing waves create thin layers of underexposed resist at the wave minima. The underexposed layers can prevent complete resist development causing edge acuity problems in the resist profile. The time required to expose the photoresist is generally an increasing function of resist thickness because of the increased total amount of radiation required to expose an increased amount of resist. However, because of the standing wave effect, the time of exposure also includes a harmonic component which varies between successive maximum and minimum values with the resist thickness. If the resist thickness is non-uniform, the problem becomes more severe, resulting in variable linewidth control.

Variations in substrate topography also give rise to resolution-limiting reflection problems. Any image on a substrate can cause impinging radiation to scatter or reflect in various uncontrolled directions, affecting the uniformity of resist development. As substrate topography becomes more complex with efforts to design more complex circuits, the effects of reflected radiation become more critical. For example, metal interconnects used on many microelectronic substrates are particularly problematic due to their topography and regions of high reflectivity.

Such radiation reflection problems have been addressed by the addition of certain dyes to photoresist compositions, the dyes absorbing radiation at, or near, the wavelength used to expose the photoresist. Exemplary dyes that have been so employed include the coumarin family, methyl orange and methanil yellow. Some workers have found that use of such dyes can limit resolution of the patterned resist image.

Another approach has been to use a radiation absorbing layer interposed between the substrate surface and the photoresist coating layer. See, for example, PCT Application WO 90/03598, and U.S. Pat. Nos. 4,910,122, 4,370,405 and 4,362,809, all of which are incorporated herein by reference for their teaching of antireflective (antireflective or ARC) compositions and use of the same. At least some prior antireflective coatings, however, suffer from poor adhesion to the overcoated photoresist layer and/or the underlying substrate surface. Such adhesion problems can severely compromise the resolution of the patterned photoresist image.

Thin ARC films have been shown to have a tendency to spontaneously dewet during the post-apply-bake step, creating pinhole defects. This problem becomes more and more common as films move to thinner thickness ranges associated with next-generation lithographic nodes. Currently, there are no good techniques to solve this problem aside from using thicker ARCs which are less prone to destabilization. However, thicker ARCs demand thicker resists in order to adequately mask the ARC in one step. This particular problem places an additional burden on the lithography method.

In a typical thermal bake, the substrate is baked at a temperature of approximately 200-225° C. after the ARC spincoating step. This bake serves two purposes. It first drives out residual solvent. In addition, once the film temperature approaches the bake plate temperature, a thermally activated crosslinking agent “freezes” the film at which point it is stabilized and pinhole defects can no longer develop. The presence of residual solvent from the spincoating step acts as a plasticizer during this bake step, reducing the glass transition of the polymer. This solvent induced Tg depression, coupled with high temperature used to cure the ARC, provide significant mobility and opportunity for the creation of pinhole defects prior to the crosslinking reaction. It would be desirable to crosslink the film at a very low temperature to stabilize the film immediately after spincasting.

While this methodology has worked well for many generations of semiconductor manufacturing, it becomes problematic as the technology approaches ultra-thin spin-cast organic films. For example, the 65 nm technology node has seen a need for bottom ARC (BARC) films having a thickness less than 50 nm. As films become this thin, the potential for spontaneous dewetting is enhanced in a very non-linear fashion, leading to pinhole defects throughout the BARC film.

Thus, it would be desirable to have new methods of forming antireflective coatings that prevent defects in the antireflective coatings.

### SUMMARY OF THE INVENTION

The present invention relates to a method that that uses a vacuum step at a reduced ambient temperature to strip the solvent from the resist film. The polymer can then be cross-linked at or near ambient temperature, avoiding the high temperature heating cycle that can accelerate the development of pinhole defects.

Another aspect of the invention relates to an antireflective coating formed from the method of the invention.

One aspect of the invention relates to a method of forming a relief image on a substrate comprising applying over a substrate a layer of an antireflective coating; and vacuum processing the antireflective coating. The substrate can be a silicon wafer or a slab of alumina, titanium, glass, polymer, or any other material known to the skilled artisan.

In another embodiment, the inventive method further comprises applying a photoresist layer over the antireflective coating layer; and exposing and developing the photoresist layer.

In another embodiment, the antireflective coating is crosslinked prior to application of the photoresist layer.

In another embodiment, the antireflective coating comprises a resin.

In another embodiment, the method further comprises a thermal acid generator.

### BRIEF DESCRIPTION OF THE DRAWING

The sole FIGURE is a pictorial representation (through cross sectional views) showing the basic methoding of the invention.

### DETAILED DESCRIPTION OF THE INVENTION

The present invention provides novel methods of forming antireflective coatings suitable for use with a photoresist. In particular, the inventive method solves the problem of forming pinhole defects in antireflective coatings (ARCs) by evacuating residual solvents in the ARC prior to any bake step. The inventive method is advantageous because it allows one to crosslink at lower temperatures without concern for entrapping volatile solvents in the crosslinked film which could promote pinhole defects and non-uniformity in the cured film.

General Scheme for forming antireflective coatings suitable for use with a photoresist.

Substrate Cleaning

Optionally, the substrate is cleaned of contaminants such as particles, metallic impurities, organic contamination, and native oxide, usually before the substrate arrives at the photolithography workbay. There are many sources of these contaminants, including people, method chemicals, method equipment, packaging and storage, substrate handling methods, and environmental conditions. Thin layers of contaminants on the substrate can consist of ionic (metallic) impurities and atomic and polymeric (organic) layers, which are all difficult to detect.

One of the major effects of contaminants on the substrate surface during photolithography is poor adhesion of the photoresist or BARC to the substrate. This condition creates a yield problem of resist lifting during development or the subsequent etch operation. Resist lifting leads to undercutting of the underlying film layer during the etch method. Particulate contamination in the resist can lead to uneven resist coating and pinholes in the resist.

In another embodiment, substrates entering the photolithography method will have just completed an oxidation or deposition operation and will be in a clean condition. These cleaned substrates can be coated with a BARC or resist, preferably soon after the cleaning. To achieve this, some fabs can place time limits on how long substrates can wait before undergoing photolithography methoding to minimize contamination adsorption on the substrate surface.

Dehydration Bake

In another embodiment, a dehydration bake can be done before substrate priming and spin coating.

Silicon substrates readily adsorb moisture on their surface. The substrate surface exposed to moisture is called hydrophilic (also called hydrated). For resist adhesion, it is preferred to have a dry or hydrophobic, substrate surface. A hydrophobic substrate is also called dehydrated and promotes good resist adhesion. In another embodiment, the substrate surface is coated with a photoresist as quickly as possible after the dehydration bake. Another method is to maintain a controlled room humidity below 50% relative humidity.

A dehydration bake can be performed in a vacuum oven. Alternatively, the dehydration bake can be done in a conventional oven at higher temperatures typically from about 200° to about 250° C. Preferably, a vacuum processing, such as a vacuum bake, is done.

Substrate Priming

In another embodiment, the substrate can be primed with a primer such as hexamethyldisilazane (HMDS), which serves as an adhesion promoter. This method is similar to a paint primer being used to prepare wood for a coat of paint. The HMDS reacts with the substrate surface to tie up molecular water, while also forming a bond with the resist material. It essentially serves as a link between the silicon and the resist so that these materials become chemically compatible. The primer can be applied by puddle, spray, or vapor methods know in the art.

Puddle Dispense and Spin:

In another embodiment, a puddle dispense and spin method can be used for single substrate methoding. The temperature and volume are easily controlled and the system requires a drain and exhaust.

Spray Dispense and Spin:

In another embodiment, a nozzle spray can be used to deposit a fine mist of HMDS on the substrate surface. An advantage of this approach is that the spray will assist in particle removal from the substrate surface.

Vapor Prime and Dehydration Bake:

Another method for applying HMDS to the substrate surface is with a vapor prime coating. The vapor priming is done at a typical temperature and time of 200° to 250° C. for 30 seconds. An advantage of vapor priming is that there is no contact with the substrate, which reduces the possibility of particulate contamination from the liquid HMDS. Vapor priming also minimizes the consumption of HMDS.

In another embodiment, a dehydration bake is followed by a vapor prime of single substrates by thermal conduction heating on a hot plate. Advantages of this approach are inside-out baking of the substrate, low defect density, uniform heating, and repeatability.

In another embodiment, the method for dehydration bake in conjunction with vapor priming is to use a vacuum chamber with a nitrogen carrier gas. This is a batch method where the substrates are placed in a quartz holder in the oven chamber. The heated chamber is evacuated and back-filled to a present pressure with HMDS vapor in the nitrogen carrier gas. At the completion of the pretreatment, the oven is evacuated and back-filled with nitrogen at atmospheric pressure.

Antireflective Coatings (ARCs)

There are two basic types of ARCs: bottom antireflective coating (BARC) beneath the photoresist to reduce substrate reflections, and top antireflective coating (TARC) deposited over the resist to reduce secondary reflections from the resist surface.

Bottom ARCs:

The BARC material is an organic or inorganic dielectric material that is applied to the substrate before the photoresist. Preferably, the BARC material is organic.

Organic BARCs reduce reflection by absorbing light and are typically spin-coated on the substrate in the same manner as the photoresist.

Inorganic BARCs are deposited by plasma-enhanced chemical vapor deposition (PECVD).

One factor in selecting an ARC is its ability to be removed after the completion of the photolithography method step. In some cases, organic BARCs, and more typically organic top ARCs, are aqueous- based and relatively easy to remove by rinsing during the development step. In another embodiment, organic ARCs can also be removed with reactive ion etch (RIE) strips, often immediately following the substrate etch as part of a multi-step process in a single chamber. This removal is typically performed with very high selectivity to the substrate features of interest.

Inorganic ARCs are more difficult to remove, especially if their chemistry is similar to the underlying layer. This ARC layer can be left on the substrate surfaces and becomes a part of the device.

Various coatings have been used over the reflective substrates to improve resist patterning control. These coatings which are antireflective, reduce interference effects and diffuse scattering. Non- limiting examples of antireflective coatings include silicon titanium nitride as an antireflective coating in a photolithographic method. In one embodiment, the method comprises the steps of interposing a layer of TiN between a metal layer, typically aluminum, and a resist layer. This is done to reduce the amount of light reflected back from the metal surface into the resist during exposure.

Top ARCs

The top antireflective coating (TARC) reduces reflection at the interface between the resist surface and air. TARC materials do not absorb light, but instead act as a transparent thin-film interference layer that uses destructive interference between light rays to eliminate reflectance.

Exposure light passes through a reticle to pattern the resist. Below the resist is the underlying layer that will ultimately be etched and patterned. If this underlying film is reflective, as with metal and polysilicon layers, then light rays reflect off this film and potentially damage the adjacent resist. This damage can adversely affect critical dimension, CD, control. The two primary light reflectivity problems are reflective notching and standing waves. Reflective notching occurs when vertical surfaces on the sides of embedded substrate structures reflect light into the resist where exposure is not intended.

Antireflective coatings are deposited on the substrate as a thin layer, typically from 200 to 2000 Å, depending on the type of ARC and material used. Dyes can also be added to the polymer matrix to help prevent light wave interference.

In one embodiment, an ARC is spincast on a substrate under normal ambient conditions to form a 42 nm thick film using commercially available Rohm and Haas AR40 ARC. After spincasting the ARC, the substrate will still contain residual solvent and will remain flexible due to the relatively low molecular weight polymer chains that make up the ARC coating.

Following the conventional ARC spincoating step, instead of moving the substrate to a high-temperature bake plate (typically 200°-225° C.), the substrate is instead moved to an ambient temperature hotplate fitting with a lid and vacuum source. By “ambient”, it is meant a temperature from about 20° C. to about 50° C., with a temperature of from about 22° C. to about 30° C. being more typical. This chamber is evacuated for a time period of approximately 30-90 seconds as needed to remove the spincoating solvent. An evacuation pressure of about 10⁻⁵ to about 10⁻⁷ Torr is typically used. Given that the ARC film is extremely thin, this step is very quick and efficient. Following this step, the film can be crosslinked via a variety of mechanisms known in the art. A low temperature thermal acid generator could be used to crosslink the film at a temperature much closer to ambient. At the temperatures used to crosslink the polymer, the film is much more resistant to developing pinhole defects since the solvent is no longer be present to plasticize the film. Alternatively, a UV-activated crosslinking agent can be used to crosslink the ARC film at ambient conditions.

A rapid vacuum step to strip the solvent, coupled with an ambient temperature UV crosslinking step could yield throughput enhancements over a conventional high-temperature bake. Typically, the high-temperature bake lasts 60-90 seconds, followed by a 60 second step on a chill plate to return the substrate to ambient conditions. By not heating the substrate above ambient conditions, this multi-step process could be avoided, replaced with a single 30-60 second process.

The inventive method is also applicable to coating other thin films including photoresists, TARCs, and spin-on dielectric insulation layers. BARC is currently among the thinnest organic spincoated films encountered in manufacturing.

In another embodiment, the present invention first takes the spincast substrate and subjects it to a vacuum step at ambient temperature conditions. This step is used to first remove the residual solvent from the BARC film prior to heating. It is well known that the mobility of polymeric films is greatly enhanced by the combination of solvents and elevated temperatures. Increasing the mobility of BARC films directly correlates to increased dewetting events in ultra-thin films.

Preferably, the vacuum step is not performed at an elevated temperature, as this is counterproductive to the goal of removing residual solvent while minimizing film mobility. Preferably, this vacuum step reaches a minimum pressure <10⁻⁵ Torr, and ideally, <10⁻⁷ Torr. Those skilled in the art will recognize that the time of exposure to vacuum required will depend on the minimum pressure achieved. Vacuum times of 3 and 5 minutes were achieved respectively. In practice with an integrated method, much shorter vacuum times are possible, on the order of seconds.

Photoresist

In another embodiment, a photoresist can be applied on the substrate surface. A photoresist is an organic compound that experiences a change in solubility in a developer solution when exposed to ultraviolet (UV) light. Photoresist used in substrate fabrication are applied to the substrate surface as a liquid but dried into a film.

Types of Photoresist

The two major types of optical photoresists are negative resist and positive resist. This classification is based on how the resist material responds to UV light. For a negative resist, the UV-exposed regions become crosslinked and hardened. This makes the exposed photoresist less soluble in the developer solution; the photoresist is not removed in the developer liquid. A negative mask image is patterned in the resist. For a positive resist, UV-exposed regions of the resist become more soluble and a positive mask image appears in the resist. A positive resist breaks down in areas exposed to light and the exposed areas are easily washed away in the developer solution. Chemically amplified (CA) resists more typically break down during post-exposure bake.

Photoresists can also be grouped based on the smallest CD that the resist can pattern. A major group is conventional resists capable of patterning linewidth dimensions down to and including 0.35 μm. A new resist technology introduced in the late 1990s CA resist for deep UV (DUV) wavelengths (see the following section). Chemically amplified resist technology can pattern fine-geometry CDS of 0.25 μm and below in high-volume production. This patterning has also been demonstrated in a lab environment for a CD of 0.05 μm. For fabrication of high performance, ICs, a substrate may be patterned with conventional resist for noncritical layers and CA resist for critical layers. We will refer to all optical resists that are not chemically amplified as conventional resists.

Photoresist Dispensing Methods

In another embodiment, a liquid photoresist can be applied on a substrate surface by spin coating to achieve a uniform coating on the substrate surface. There are four basic steps to applying resist by spin coating.

1. Dispense: The resist is dispensed onto the substrate while it is stationary or spinning very slowly.

2. Spin-up: The substrate rotation is accelerated to a high rpm (revolutions per minute) spin speed to spread the resist over the entire substrate surface.

3. Spin-off: Excess resist is thrown off to obtain a uniform resist film coating on the substrate.

4. Solvent evaporation: The coated substrate is spun at a constant rpm until the solvent evaporates and the resist film is nearly dry.

Preferably, the resist spin coating results in a uniform film coating on a substrate and to achieve a repeatable resist thickness that is maintained from substrate to substrate over extended periods. The target resist thickness is specified for a particular application and is typically thinner for the most advanced critical layers, frequently in the range of 200-300 nm. Thickness variation of the resist film on a substrate is preferably less than 20 to 50 Å across the entire substrate surface. Substrate-to-substrate resist thickness control is preferably less than 30 Å.

Spin Coating Equipment:

Substrate spin coating can take place in an automated substrate track system known in the art with substrate handling equipment to move the substrates from operation to operation. Robotic handling is preferred over conveyors to minimize particle generation and substrate damage.

Spin Coating Parameters:

The manner of dispensing the liquid resist can vary. The resist can be dispensed on a substrate while it is not rotating, known as static dispense. After the static dispense, the substrate is first spun at a low rpm to uniformly spread the resist. Once the resist approaches the substrate edge, the rpm is accelerated to a final spin speed (e.g. a typical final speed may be 1,500 rpm). Another approach is to dispense the resist on a substrate that is spinning slowly (e.g. 100 to 200 rpm) in order to uniformly coat the substrate, followed by acceleration to the final spin speed. This is referred to as a dynamic dispense.

The antireflective coatings may suitably contain a resin component in addition to the base additive material. Suitable resin components may contain chromophore units for absorbing radiation used to image an overcoated resist layer before undesired reflections can occur.

In another embodiment, the resin (also referred to herein as resin binder) of the antireflective coatings comprises quinolinyl groups, which includes optionally substituted groups or quinolinyl derivatives that have one or more N, O or S ring atoms such as a hydroxyquinolinyl. The polymer may contain other units such as carboxy and/or alkyl ester units pendant from the polymer backbone.

In other aspects, the resin can be a phenolic binder that contains phenolic OH sites bonded to another moiety such as acid labile groups e.g. those groups disclosed in U.S. Pat. No. 5,258,257 to Sinta et al., or inert blocking groups as described in U.S. Pat. No. 5,514,520 to Thackeray et al.

Other phenolic resins that can be employed as resin binder precursors include novolak and poly(vinylphenol) resins. Preparation of such phenolic resins is known. Examples of suitable phenols for condensation with an aldehyde, especially formaldehyde, for the formation of novolak resins include phenol; m-cresol; o-cresol; p-cresol; 2,4-xylenol; 2,5-xylenol; 3,4-xylenol; 3,5-xylenol; thymol and mixtures thereof. An acid catalyzed condensation reaction results in formation of a suitable novolak resin which may vary in molecular weight from about 500 to 100,000 daltons. Poly(vinylphenols) may be prepared, e.g., as disclosed in U.S. Pat. No. 4,439,516. Additional resins and the preparation thereof are also disclosed in U.S. Pat. No. 5,128,230.

Additionally, two or more resins of similar or different compositions can be blended or combined together to give additive control of lithographic properties of a photoresist composition.

A variety of photoresist compositions can be employed with the antireflective coatings of the invention, including positive-acting and negative-acting photoacid-generating compositions. Photoresists used with antireflective coatings of the invention can also comprise a resin binder and a photoactive component, typically a photoacid generator compound. The photoresist resin binder has functional groups that impart alkaline aqueous developability to the imaged resist composition.

Negative-acting resist compositions for use with an antireflective coating of the invention can include a mixture of materials that will cure, crosslink or harden upon exposure to acid, and a photoacid generator. Non-limiting examples of negative-acting resist compositions comprise a resin binder such as a phenolic resin, a crosslinker component and a photoactive component of the invention. Such compositions and uses thereof have been disclosed in European Patent Applications 0164248 and 0232972 and in U.S. Pat. No. 5,128,232 to Thackeray et al. Preferred phenolic resins for use as the resin binder component include novolaks and poly(vinylphenol)s such as those discussed above. Additional examples of crosslinkers include amine-based materials, including melamine, glycolurils, benzoguanamine-based materials and urea-based materials. Such crosslinkers are commercially available. Other non-exclusive examples of crosslinking agents include hexamethylol melamine ether as disclosed in U.S. Pat. No. 4,581,321; as well as crosslinking agents and methods disclosed in U.S. Pat. Nos. 4,104,070; 4,196,003, 4,576,901 and 4,506,006; as well as the dimethylol paracresol and other classes of crosslinkers disclosed in U.S. patent application Ser. No. 06/895,609 all of which are incorporated herein by reference.

Suitable photoacid generator compounds of resists that can be used with the method the invention include a sulfonate having an optionally substituted phenyl substituent, an optionally substituted benzenesulfonate salt, a para-alkylbenzenesulfonate salt, a toluenesulfonate acid amine salt, a sulfonate having an optionally substituted anthracene substituent, and a nitrogen-containing cation component.

Examples of photoacid generators include onium salts, such as those disclosed in U.S. Pat. Nos. 4,442,197, and 4,624,912, each of which are incorporated herein by reference; non-ionic organic photoactive compounds such as the halogenated photoactive compounds disclosed in U.S. Pat. No. 5,128,232 to Thackeray et al. and sulfonate photoacid generators including sulfonated esters and sulfonlyoxy ketones. See J. of Photopolymer Science and Technology, 4(3):337-340 (1991).

Photoresists for use with an antireflective coating of the invention also can contain other materials. For example, other optional additives include actinic and contrast dyes, anti-striation agents, plasticizers, speed enhancers, etc. Such optional additives typically will be present in minor concentration in a photoresist composition except for fillers and dyes which may be present in relatively large concentrations such as, e.g., in amounts of from about 5 to 50 percent by weight of the total weight of a resist's dry components.

In use, an antireflective coating can be applied as a coating layer to a substrate by any of a variety of methods such as spin coating. The antireflective coating in general is applied on a substrate with a dried layer thickness ranging from about 0.2 to about 0.5 μm, preferably a dried layer thickness from about 0.04 to about 0.1 μm for 193 nm lithography processes. The substrate is suitably any substrate used in methods involving photoresists. For example, the substrate can be silicon, silicon dioxide or aluminum-aluminum oxide microelectronic wafers. Gallium arsenide, silicon carbide, ceramic, quartz or copper substrates may also be employed. Substrates for liquid crystal display or other flat panel display applications are also suitably employed, for example glass substrates, indium tin oxide coated substrates and the like. Substrates for optical and optical-electronic devices (e.g. waveguides) also can be employed.

The exposed resist coating layer can be developed, for example, with an aqueous based developer such as an alkali exemplified by tetra butyl ammonium hydroxide, sodium hydroxide, potassium hydroxide, sodium carbonate, sodium bicarbonate, sodium silicate, sodium metasilicate, aqueous ammonia or the like. Alternatively, organic developers can be used. In general, development is in accordance with art recognized procedures.

The developed substrate may then be selectively methoded on those substrate areas bared of photoresist, for example, chemically etching or plating substrate areas bared of photoresist in accordance with procedures well known in the art. Suitable etchants include a hydrofluoric acid etching solution and a plasma gas etch such as an oxygen plasma etch. A plasma gas etch removes the crosslinked antireflective coating layer.

Another optional additive of the antireflective coatings are compounds that serve as dyes and absorb radiation used to expose an overcoated photoresist layer. The dye should absorb well at the wavelength at which the overcoated photoresist is exposed and, therefore, selection of a suitable dye for a specific antireflective composition in large part will be determined by the particular photoresist that is employed. For example, if an antireflective coating is used in combination with a deep U.V. photoresist (i.e., a resist that is exposed at between 100 and 300 nm), the dye compound should strongly absorb in the deep U.V. region. Suitable dyes are known in the art and include, for example, the curcumin family and derivatives thereof, anthracene, anthrarobin, Sudan-orange, benzophenothiazine and naphthol-AS. Typically a dye is present in an antireflective coating in a concentration of from about 2 to 30 percent by weight of the total of the dry components of the composition, more preferably from 5 to 15 percent by weight of the total dry components.

A variety of photoresist compositions can be employed in the invention. In another embodiment, a photoresist is employed that, when coated over a film layer of antireflective-composition, is capable of crosslinking with the antireflective composition at the interface of the two coating layers. More specifically, photoresists for use with the antireflective-coatings include positive-acting and negative-acting photoacid-generating compositions that comprise a resin system that can crosslink with one or more components of the antireflective coatings.

In another embodiment, photoresists that can be employed in the invention comprise a radiation sensitive component such as a photoacid generator compound and a mixture of materials that will cure, crosslink or harden upon heating and exposure to acid. In another embodiment, the mixture of materials comprises a phenol-based resin binder and an amine-based crosslinker. Suitable phenol-based resins include novolak resins, poly(vinylphenols) and various copolymers thereof. Suitable amine-based crosslinkers include those described above for the antireflective compositions, in particular the melamine-formaldehyde Cymel resins available from American Cyanamid. Suitable photoacid generator compounds include the onium salts, such as those disclosed in U.S. Pat. Nos. 4,442,197, 4,603,101, and 4,624,912, each incorporated herein by reference; and non-ionic organic photoactive compounds such as the halogenated photoactive compounds disclosed in the below referenced European Patent Applications. These photoactive compounds should be present in a photoresist in an amount sufficient to enable development of a coating layer of the resist following exposure to activating radiation. Preferred negative-acting photoresists include the acid-hardening photoresists as disclosed, for example, in European Patent Applications Nos. 0401499 and 0423446, both incorporated herein by reference. As used herein, the term “acid-hardening photoresist” refers to photoresist compositions of the general type described above and in these referenced European Patent Applications.

Other photoresists that can be used include positive-acting photoresists that contain components that can crosslink with one or more components of the antireflective compositions. Such photoresists suitably comprise a phenol-based resin binder in combination with a radiation sensitive component. Suitable resin binders include novolak resins, poly(vinylphenols) and various copolymers thereof. Suitable radiation sensitive components can comprise a variety of photoacid generator compounds including the naphthoquinone diazide sulfonic acid esters such as 2,1,4-diazonaphthoquinone sulfonic esters and 2,1,5-diazonaphthoquinone sulfonic acid esters; the onium salts; and other known acid generators such as those disclosed in European Patent Application Nos. 0164248 and 0232972, both incorporated herein by reference. In addition to “conventional” positive-acting resists, chemically amplified positive resists are particularly suitable for use with the antireflective compositions. As with the above described acid-hardening resists, a chemically amplified positive resist generates a catalytic photoproduct upon exposure to activating radiation. In a positive system, this photoproduct (e.g., acid) renders the exposed regions of the resist more developer soluble, for example by catalyzing a deprotection reaction of one or more of the resist components to liberate polar functional groups such as carboxy. See, Lamola, et al., “Chemically Amplified Resists”, Solid State Technology, 53-60 (August 1991), incorporated herein by reference.

The developed substrate may then be selectively methoded on those substrates areas bared of photoresist, for example chemically etching or plating substrate areas bared of photoresist in accordance with procedures well known in the art. Suitable etchants include a hydrofluoric acid etching solution and a plasma gas etch such as an oxygen plasma etch. In particular, a plasma gas etch readily penetrates the crosslinked antireflective-coating layer.

Reference is now made to the FIGURE of the drawing which shows a preferred method for use of an antireflective composition of the invention.

In Step A, an antireflective composition is applied to substrate 10 to provide antireflective coating layer 12. The antireflective composition may be applied by virtually any standard means including spin coating. The antireflective composition in general is applied on a substrate with a dried layer thickness of between about 0.02 and 0.5 μm, preferably a dried layer thickness of between about 0.04 and 0.10 μm. The substrate is suitably any substrate conventionally used in processes involving photoresists. For example, the substrate can be silicon, silicon dioxide or aluminum-aluminum oxide microelectronic wafers. Gallium arsenide, ceramic, quartz or copper substrates may also be employed. Substrates used for liquid crystal display applications are also suitably employed, for example glass substrates, indium tin coated substrates and the like.

In Step B, residual solvent is evacuated from the antireflective coating layer 12 using the inventive processing described above.

In Step C, the antireflective coating layer 12 is crosslinked to the substrate 10. A low thermal acid generator could be used to crosslink the film at close to ambient temperature. Alternatively, a U.V. activating crosslinking agent can be used to crosslink the film at ambient conditions

In Step D, a photoresist is applied over the surface of the crosslinked antireflective layer 12. As with the application of the antireflective composition, the photoresist can be applied by any standard means such as by spinning, dipping or roller coating. When spin coating, the solids content of the photoresist composition can be adjusted to provide a desired film thickness based upon the specific spinning equipment utilized, the viscosity of the solution, the speed of the spinner and the amount of time allowed for spinning. Following application, the photoresist coating layer 14 is typically dried by heating to remove solvent preferably until layer 14 is tack free. Optimally, no intermixing of the antireflective layer and photoresist layer should occur.

In Step E, coating layer 14 is imaged with activating radiation through a mask in conventional manner. The exposure energy is sufficient to effectively activate the photoactive component of the radiation sensitive system to produce a patterned image 16 in coating layer 14. The exposure energy typically ranges from about 10 to 300 mJ/cm², dependent upon the exposure tool.

In Step F, the exposed resist coating layer 14 is developed, preferably with an aqueous based developer such as an inorganic alkali exemplified by sodium hydroxide, potassium hydroxide, sodium carbonate, sodium bicarbonate, sodium silicate, sodium metasilicate, aqueous ammonia or the like. Alternatively, organic developers can be used such as choline based solutions; quaternary ammonium hydroxide solutions such as a tetra-alkyl ammonium hydroxide solution; various amine solutions such as ethyl amine, n-propyl amine, diethyl amine, di-n-propyl amine, triethyl amine or, methyldiethyl amine; alcohol amines such as diethanol amine or triethanol amine; cyclic amines such as pyrrole, piperidine, etc. In general, development is in accordance with art recognized procedures.

The following examples are presented to better illustrate the invention, but are not to be construed as limiting the invention to the specific embodiments disclosed.

### EXAMPLES

### Example 1

Two bare silicon wafers with a thin native oxide coating were coated with an ARC on a lithography track. The wafers were then subjected to a mild vacuum-strong vacuum to remove residual solvent. By “mild vacuum”, it is meant 10⁻⁵ Torr. By “strong vacuum”, it is meant 10⁻⁷ Torr. The wafers were then returned to the lithography track and baked at conventional bake temperature.

The total number of pinhole defects in each of the two wafers were 9 and 5 in the mild vacuum and 5 and 5 in the strong vacuum (See Table 1). These results show that there was a significant reduction in the total number of defect counts on the wafers that had intermediate and strong vacuum based solvent strip compared to the wafers without a vacuum based solvent strip.

Following this vacuum exposure step, the substrate was placed on a hotplate to activate the crosslinking agent. Commercially available AR40 BARC, was baked at a conventional 215° C. bake temperature for 60 seconds. Results are shown below comparing total dewetting defects in a conventional BARC method to our modified method:

| | Substrate | Total Pinhole |
|---|---|---|
| BARC Curing Method | ID | Defects |
| Current art - Immediate | 18 | 16 |
| crosslinking bake | 19 | 38 |
| Strong vacuum followed | 4 | 5 |
| by crosslinking bake | 17 | 5 |
| Mild vacuum followed | 15 | 9 |
| by crosslinking bake | 16 | 5 |

The above table illustrates that there is a significant reduction in pinhole defects through the use of a two step method starting with a vacuum strip of solvent followed by a curing bake at elevated temperatures.

The inventive method also enables the use of much lower temperatures for the BARC bake, which can have a secondary benefit towards reducing film mobility. The use of high-temperature thermal acid generators is dictated partially by the need to ensure the solvent is first driven out of the film prior to the crosslinking step. This helps to ensure that solvent is not entrapped in a matrix of crosslinked polymer. In fact, another embodiment may be proposed in which one first uses a vacuum solvent removal step followed by a UV cure at ambient temperatures. In this fashion, the film is never heated prior to the crosslinking step. This can eliminate the need to heat thin polymer films above their glass transition temperature, thus further eliminating any opportunity for mobility and pinhole formation.

The foregoing description of the invention is merely illustrative thereof, and it is understood that variations and modifications can be effected without departing from the scope or spirit of the invention as set forth in the following claims.

What is claimed is:

1. A method of forming a relief image on a substrate comprising:
applying over a substrate a layer of an antireflective coating; and
vacuum processing the antireflective coating prior to curing.

2. The method according to claim 1, further comprising applying a photoresist layer over the antireflective coating layer; and exposing and developing the photoresist layer.

3. The method according to claim 1, further comprising adding a thermal acid generator selected from the group consisting of a sulfonate having an optionally substituted phenyl substituent, an optionally substituted benzenesulfonate salt, a para-alkylbenzenesulfonate salt, a toluenesulfonate acid amine salt, a sulfonate having an optionally substituted anthracene substituent, and a nitrogen-containing cation component.

4. The method according to claim 1 further comprising adding a material capable of undergoing a thermally induced crosslinking reaction to said antireflective coating.

5. The method according to claim 4, wherein the antireflective coating is crosslinked prior to application of the photoresist layer.

6. The method according to claim 4, wherein the material capable of undergoing a thermally induced crosslinking reaction is an amine based crosslinker.

7. The method according to claim 1, wherein the antireflective coating comprises a resin selected from the group consisting of chromophore units, quinolinyl groups, a phenol based polymer, and an anthracene based polymer.

8. The method according to claim 1, wherein the substrate is selected from the group consisting of silicon, silicon dioxide, aluminum-aluminum oxide microelectronic wafers, gallium arsenide, silicon carbide, ceramic, quartz and copper substrates.

9. The method according to claim 1, wherein the vacuum processing is performed at or near ambient temperature.

10. The method according to claim 9, wherein said ambient temperature is from about 20° C. to about 50° C.

11. The method according to claim 10, wherein said ambient temperature is from about 22° C. to about 30° C.

12. The method according to claim 10, wherein said vacuum processing is performed at a pressure from about 10⁻⁵ to about 10⁻⁷ Torr.

13. An antireflective coating formed from the method according to claim 1.
